(19) United States
(12) Patent Application Publication
(10) Pub. No.: US 2019/0353610 A1
(43) Pub. Date: Nov. 21, 2019

(54) PRINTED GRAPHENE-BASED BIOSENSOR

(71) Applicant: BOISE STATE UNIVERSITY, Boise, ID (US)

(72) Inventors: Twinkle Pandhi, Boise, ID (US); David Estrada, Boise, ID (US); Jessica Koehne, Moffett Field, CA (US)

(21) Appl. No.: 16/415,932

(22) Filed: May 17, 2019

Related U.S. Application Data
(60) Provisional application No. 62/672,730, filed on May 17, 2018.

(51) Int. Cl. G01N 27/327; G01N 27/414

(52) U.S. Cl. CPC G01N 27/3275; G01N 27/414

(57) ABSTRACT

A method may include selecting a target level of porosity associated with a graphene trace of an electrochemical sensor, the target level of porosity between 3% and 24%. The method may further include selecting a concentration and a viscosity of a graphene ink based on the target level of porosity. The method may also include selecting at least one printing parameter and at least one sintering parameter based on the target level of porosity. The method may include printing the graphene ink onto a substrate using the number of print passes to form the graphene trace having the target level of porosity. A system may include a substrate and a printed graphene trace having a porosity of between 3% and 24% printed onto the substrate, where the graphene trace defines at least a portion of an electrochemical sensor.

### CROSS-REFERENCE TO RELATED APPLICATIONS

This application claims priority to and the benefit of U.S. Provisional Patent Application No. 62/672,730, filed on May 17, 2018 and entitled “Fully Inkjet Printed Graphene-based Biosensor for Flexible and Wearable Electronics,” the contents of which are hereby incorporated by reference herein in their entirety.

### GOVERNMENT LICENSE RIGHTS

This invention was made with government support under Contract No. NNX15AK35A awarded by NASA. The government has certain rights in the invention

### FIELD OF THE DISCLOSURE

This disclosure is generally related to graphene printing systems and methods, and in particular to printed graphene-based biosensors.

### BACKGROUND

Due to its high specific surface area, high carrier mobility, and tunable crystal defect density, graphene has shown potential in electronic related applications. Graphene is hypothesized to be a great sensor material due to its flexible nature, high surface to volume ratio, unique band structure, and high electrochemical activity. Typical graphene-based sensors may be fabricated using etching techniques or other chip fabrication techniques.

However, fully printing graphene onto a substrate, either through ink-jet printing processes or aerosol jet printing processes typically results in inconsistent results when used in sensitive biosensing applications. Typical fully-printed sensors, as opposed to other forms of fabrication, may not exhibit sufficient electrochemical sensitivity and may not be operational under realistic environmental conditions. One source of complication is the interaction of printed graphene with an underlying substrate. Surface roughness, surface energies, adhesiveness, and chemical reactivity, can affect the quality and properties of the printed structure.

Because of the interaction of ink with a substrate, current ink fabrication processes and printing processes may not result in consistent and repeatable results for graphene-based biosensors. In particular, current ink fabrication processes may not take into consideration the effect that a type of printing process, a number of print passes, an ink concentration and viscosity, and/or other parameters may have on the overall porosity of a graphene sensor, where the porosity is directly related to the corresponding electrochemical characteristics of the sensor. Other disadvantages may exist.

### SUMMARY

Disclosed is a process for forming a graphene-based sensor that may overcome at least one of disadvantages of current graphene printing processes. In an embodiment, a method includes selecting a target level of porosity associated with a graphene trace of an electrochemical sensor. The target level of porosity may be between 3% and 24%. The method further includes selecting a concentration and a viscosity of a graphene ink based on the target level of porosity. The method also includes selecting at least one printing parameter and at least one sintering parameter based on the target level of porosity. The method includes printing the graphene ink onto a substrate using the number of print passes to form the graphene trace having the target level of porosity.

In some embodiments, the target level of porosity is selected to be 15%. In some embodiments, the concentration of the graphene ink is selected to be about 3.5 mg/ml. In some embodiments, the viscosity of the graphene ink is selected to be about 3.6 cP. In some embodiments, the at least one printing parameter includes a number of print passes and is selected to be between 10 and 30. In some embodiments, the at least one sintering parameter includes a sintering temperature selected to be at least 350° C. and a sintering time selected to be at least 60 minutes for an inkjet printing process. In some embodiments, the at least one sintering parameter includes a sintering temperature selected to be at least 200° C. and a sintering time selected to be at least 60 minutes for an aerosol jet printing process.

In some embodiments, the method includes dispersing dried graphene flakes into a mixture of cyclohexanone and terpineol to form the graphene ink. In some embodiments, printing the graphene ink comprises using an inkjet process, where the mixture of cyclohexanone and terpineol includes 85 wt % cyclohexanone and 15 wt % terpineol. In some embodiments, printing the graphene ink comprises using an aerosol jet process, where the mixture of cyclohexanone and terpineol includes 92.5 wt % cyclohexanone and 7.5 wt % terpineol. In some embodiments, the substrate is a flexible substrate configured to conform to biological surfaces with the graphene trace in contact with the biological surface.

In an embodiment, a method includes dispersing dried graphene flakes into a mixture of cyclohexanone and terpineol to form a graphene ink having a graphene concentration of about 3.5 mg/ml and a viscosity of about 3.6 cP. The method further includes printing the graphene ink onto a substrate to form a graphene trace, the graphene trace defining a portion of an electrochemical sensor, and the graphene trace having a level of porosity of about 15%.

In some embodiments, printing the graphene ink onto the substrate comprises using between 10 and 30 print passes. In some embodiments, printing the graphene ink comprises using an inkjet process, wherein the cyclohexanone is 85% and the terpineol is 15% and the method includes sintering the graphene trace for 60 minutes at 350° C. In some embodiments, printing the graphene ink comprises using an aerosol process, where the cyclohexanone is 92.5% and the terpineol is 7.5%, and where the method includes sintering the graphene trace for 60 minutes at 350° C. In some embodiments, the method includes forming the dried graphene flakes by adding bulk powders to a solution of 4% ethyl cellulose in ethanol to form a bulk mixture, probe tip sonicating the bulk mixture for at least 90 minutes, centrifuging the bulk mixture at 4500 rotations per minute for at least 60 minutes to form a supernatant, adding the supernatant to a 0.04 g/ml aqueous solution of NaCl to form a graphene mixture, centrifuging the graphene mixture for 15 minutes at 4500 rotations per minute, and drying the graphene mixture on a Polytetrafluoroethylene plate.

In an embodiment, a system includes a substrate and a printed graphene trace having a porosity of between 3% and 24% printed onto the substrate. The graphene trace may define at least a portion of an electrochemical sensor. In some embodiments, the porosity is of the printed graphene trace is about 15%.

### BRIEF DESCRIPTION OF THE DRAWINGS

FIG. 1 depicts an embodiment of a system process for forming a graphene-based sensor.

FIG. 2 is a graph depicting height profiles for graphene traces printed using varying numbers of print passes on a Si/SiO2 substrate.

FIG. 3 is a graph depicting peak heights and full-width at half-maximum values of graphene traces printed on a Si/SiO2 substrate as a function of a number of print passes.

FIG. 4 is a graph depicting resistivity of graphene traces printed on a Si/SO2 substrate as a function of trace length.

FIG. 5 is a graph depicting conductance of graphene traces printed on a Si/SO2 substrate as a function of a number of print passes.

FIG. 6 is a photograph demonstrating a level of porosity of a graphene trace printed on a Si/SO2 substrate.

FIG. 7 is a graph depicting a voltage-current response of a graphene trace printed with 15 print passes on a Si/SO2 substrate at multiple scan rates.

FIG. 8 is a graph depicting a voltage-current response of a graphene trace printed with 20 print passes on a Si/SO2 substrate at multiple scan rates.

FIG. 9 is a graph depicting a voltage-current response of a graphene trace printed with 25 print passes on a Si/SO2 substrate at multiple scan rates.

FIG. 10 shows a voltage-current response of multiple graphene electrodes printed on a Si/SO2 substrate. FIG. 10 demonstrates the repeatability of the methods described herein. Typical methods do not result in repeatability.

FIG. 11 is a graph depicting a pH response of a graphene electrode printed on a Si/SO2 substrate as a function of time for multiple pH levels.

FIG. 12 is a graph depicting a pH response of graphene electrodes as a function of pH.

FIG. 13 is a flow chart depicting an embodiment of a method for forming a graphene-based sensor.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure.

### DETAILED DESCRIPTION

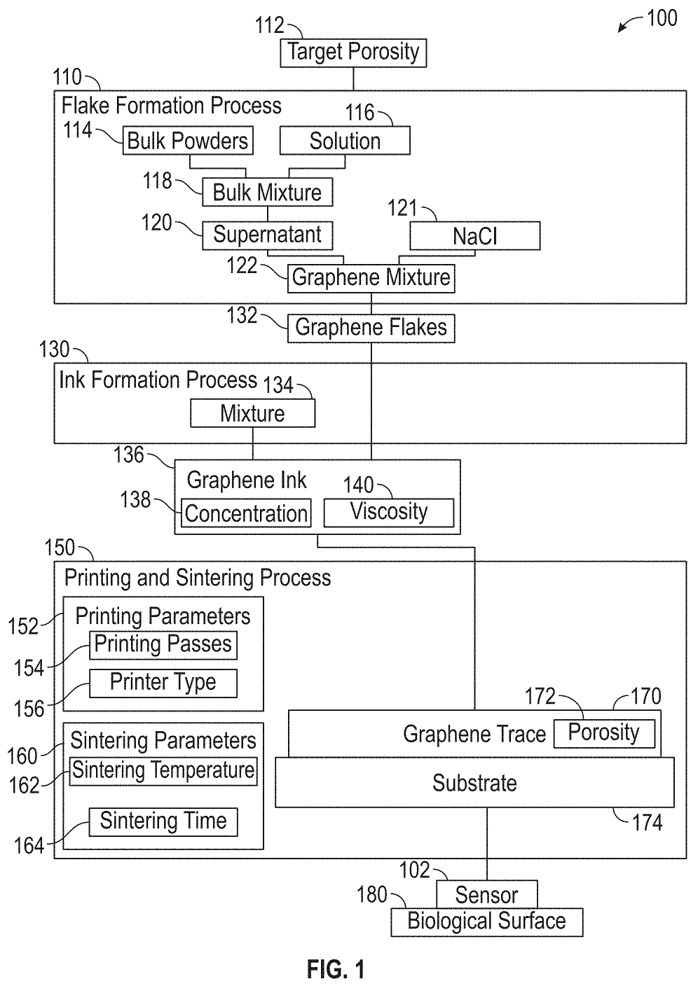

Referring to FIG. 1, an embodiment of a system process 100 for forming a graphene-based sensor 102 is depicted. The graphene-based sensor 102 may be an electrochemical sensor. In particular, the graphene-based sensor 102 may be a biosensor configured to be placed in contact with and conform to a biological surface 180. The process 100 may include a flake formation process 110, an ink formation process 130, and a printing and sintering process 150. By understanding the parameters of ink synthesis and printing conditions, repeatable electrochemical performance may be achieved in sensors produced by the process 100, such as the graphene-based sensor 102.

A target porosity 112 for a graphene trace 170 of the sensor 102 may be selected to achieve a desired conductivity. The porosity 112 of the graphene trace 170 may be functionally related to the conductivity of the graphene trace 170 and also to the efficacy of the graphene trace 170 for sensing biological processes. While typical methods for forming graphene traces may be inconsistent and may be difficult to reproduce, the process 100 described herein including the flake formation process 110, the ink formation process 130, and the printing and sintering process 150 may consistently result in achieving the target porosity 112 based on selected parameters. The target porosity may be selected between 3% and 24%, and in a non-limiting example, the target porosity may be 15%.

The flake formation process 110 may include forming the dried graphene flakes 132 by adding bulk powders 114 to a solution 116 of ethyl cellulose in ethanol to form a bulk mixture 118. The solution 116 may include 4% ethyl cellulose. After the bulk mixture 118 is formed, it may be probe tip sonicated for a period of time. For example, the bulk mixture 118 may be probe tip sonicated for at least 90 minutes. Afterward, the bulk mixture 118 may be centrifuged at 4500 rotations per minute for at least 60 minutes. The probe tip sonication and centrifuge may cause the bulk mixture 118 to form a supernatant 120. The supernatant 120 may be added to an aqueous solution of NaCl to form a graphene mixture 122. For example, the aqueous solution may be a 0.04 g/ml aqueous solution of NaCl. The graphene mixture 122 may be centrifuged for 15 minutes at 4500 rotations per minute. Afterward the graphene mixture 122 may be dried on a Polytetrafluoroethylene plate to form graphene flakes 132.

In order to achieve the target porosity 112, a concentration 138 and viscosity 140 of a graphene ink 136 may be selected. The selection of the concentration 138 and the viscosity 140 may be determined based on parameters associated with the printing and sintering process 150 as well in order to achieve the target porosity 112. In a sample, embodiment, the concentration of the graphene ink may be selected to be about 3.5 mg/ml. The viscosity of the graphene ink 136 may be selected to be about 3.6 cP.

The ink formation process 130 may include dispersing the graphene flakes 132 into a mixture 134 of cyclohexanone and terpineol to form the graphene ink 136. Different concentrations of the mixture 134 may be used depending on a type of printing process. For example, when using an inkjet process, the mixture of cyclohexanone and terpineol may include 85 wt % cyclohexanone and 15 wt % terpineol. As another example, when an aerosol jet process is used, the mixture of cyclohexanone and terpineol includes 92.5 wt % cyclohexanone and 7.5 wt % terpineol. After the graphene ink 136 is formed, it may be printed onto a substrate 174 to form the graphene trace 170.

The printing and sintering process 150 may include printing parameters 152 and sintering parameters 160. The printing parameters 152 may include, among other parameters, a number of print passes 154 and a printer type 156. The sintering parameters 160 may include, among other parameters, a sintering temperature 162 and a sintering time 164. Each of these printing parameters 152 and the sintering parameters 160 may be selected to result in the target porosity 112.

In an example, the number of print passes 154 may be selected to be between 10 and 30. The printer type 156 may be selected to correspond to an inkjet printing process. The sintering temperature 162 may be selected to be at least 350° C. The sintering time 164 may be selected to be at least 60 mins.

In another example, the number of print passes 154 may be selected to be between 10 and 30. The printer type 156 may be selected to correspond to an aerosol jet printing process. The sintering temperature 162 may be selected to be at least 200° C. The sintering time 164 may be selected to be at least 60 minutes.

The graphene ink 136 may be printed onto the substrate 174 using the number of print passes 154 to form the graphene trace 170. Based on the parameters 152, 160, the graphene trace 170 may have a porosity 172 that substantially equals the target level of porosity 112. The graphene trace 170 and the substrate 174 may be included within the sensor 102. Further, the substrate 174 may be a flexible substrate configured to conform to biological surfaces with the graphene trace in contact with the biological surface.

A benefit of the process 100 is that repeatable electrical characteristics of the graphene trace 170 may be achieved. Typical graphene printing processes use prefabricated inks with lower viscosity and rely on fewer print passes, which may result in unreliable results for biosensor applications because biosensors typically have stringent electrochemical requirements. Other benefits may exist.

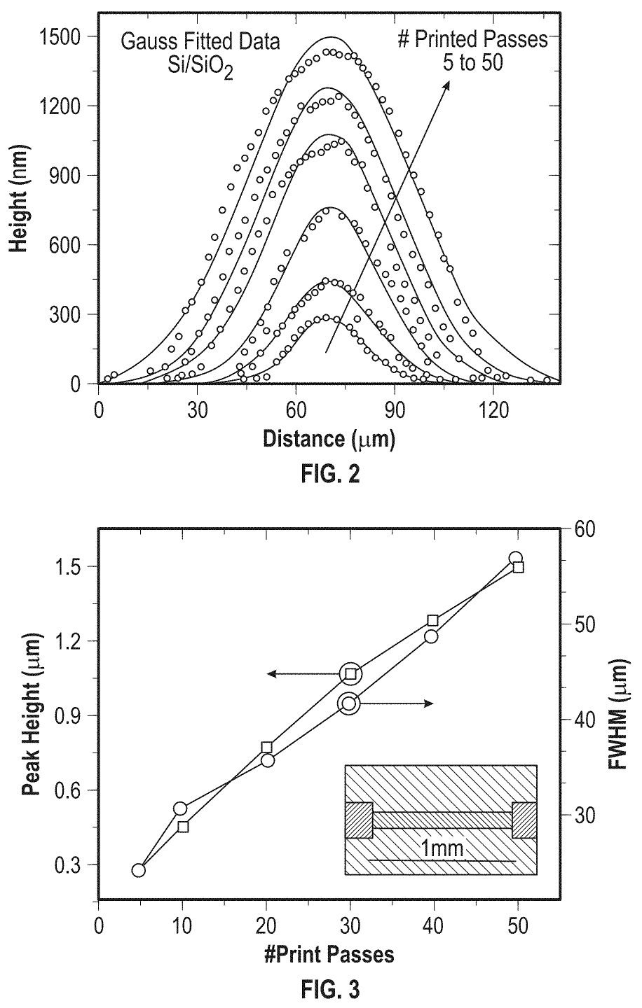

Referring to FIG. 2 a graph depicts height profiles for graphene traces printed using varying numbers of print passes on a Si/SiO2 substrate. The height data depicted in FIG. 2 shows a uniform deposition rate with an increase in height directly correlated to the number of passes. Although FIG. 2 is directed to a Si/SO2 substrate, other substrate materials (e.g., Al2O3, Kapton™, etc.) may have a similar height profile.

Referring to FIG. 3, a graph depicts peak heights and full-width at half-maximum (FWHM) values of graphene traces printed on a Si/SiO2 substrate as a function of a number of print passes. The linear relation of the FWHM and peak height data provides additional support for the correlation between the number of print passes and increased height.

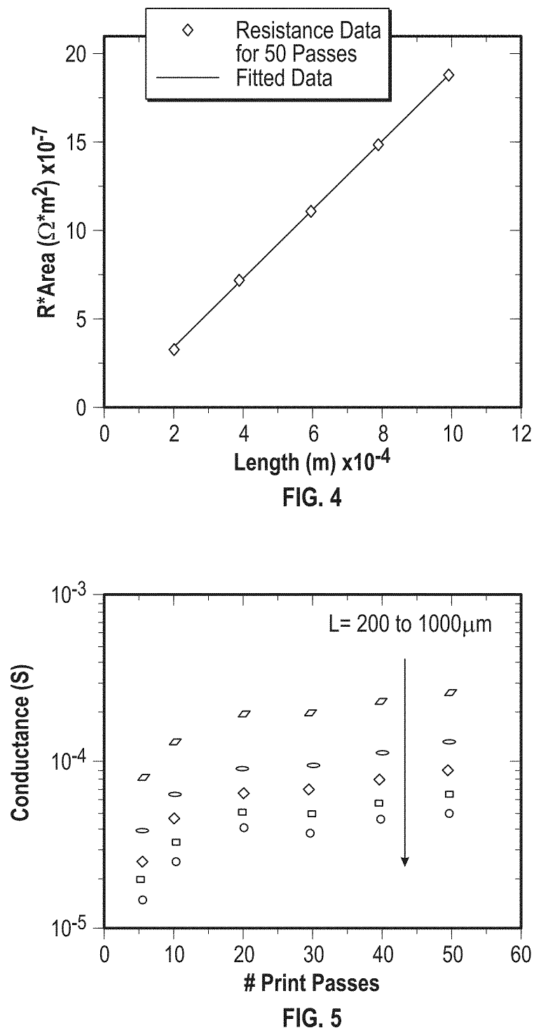

Referring to FIG. 4 a graph depicts resistivity of graphene traces printed on a Si/SO2 substrate as a function of trace length. For example, a resistance-area value of a graphene trace is depicted as a function of length of the graphene trace. Referring to FIG. 5 a graph depicts conductance of graphene traces printed on a Si/SO2 substrate as a function of a number of print passes. As shown in FIG. 5, the conductance generally increases greatly from 5 to 20 print passes and appears to taper somewhat at greater than 20 print passes.

In the test cases described in FIG. 5, the electrical conductance increased by a factor of 30 with increasing number of passes from 5 to 50, with a sheet resistance of about 1.5 kΩ/m for a 50-pass line. The power dissipation of a graphene device may be dependent on the effective thermal conductivity and total thermal resistance of the system. Substrate material, interface thermal resistances, graphene quality, and device structure are a few of the factors that may impact the total device thermal resistance. To study this effect, a simple lumped model was developed that uses a combination of infrared (IR) thermal imaging and electrical breakdown thermometry supported by finite element modeling (FEM). The total thermal resistance of the interconnect on SiO₂/Si was calculated to be 372 K/W, with the highest temperature value of 520° C. being reached within the graphene trace. The high thermal resistance of the graphene traces is likely due to several factors: the porosity of the printed interconnect, the high thermal resistance between graphene layers, and the general disorder of the constituent graphene nanoflakes that make up the interconnect. This highlights the importance of the process 100 described in FIG. 1.

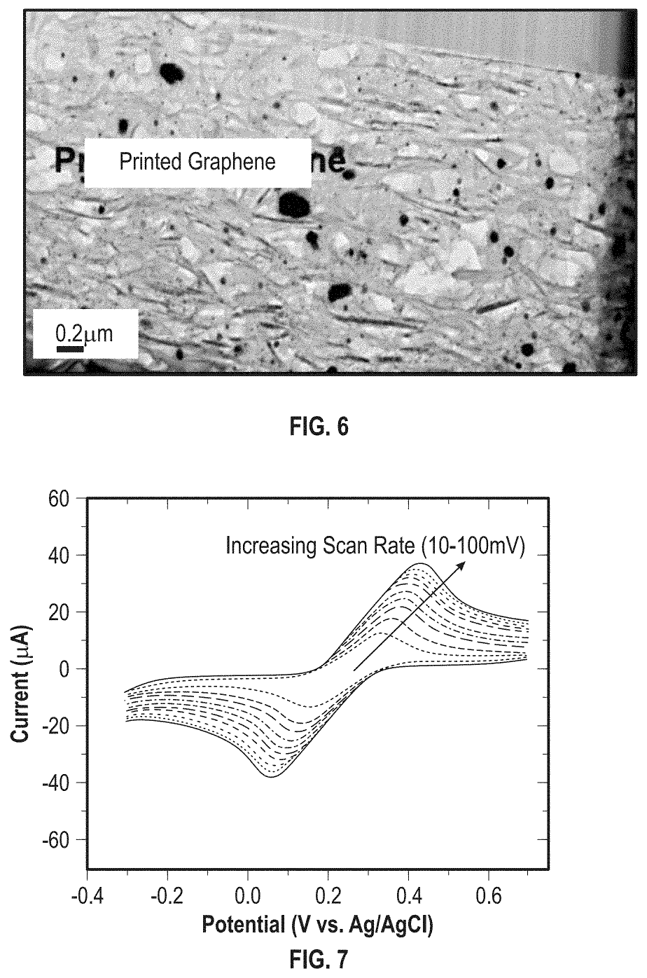

FIG. 6 is a photograph depicting a cross-section of a graphene trace printed on Si/SO2 and demonstrating a level of porosity. Cross-sectional TEM imaging was used to quantify the porosity of the printed graphene on SiO₂/Si. Analysis of the TEM image of FIG. 6 indicates 15% porosity in the graphene trace. Further, a porosity at the graphene-substrate interface may reduce the total area for heat flow across the interface, increasing the thermal interface resistance. The high porosity depicted in FIG. 6 may help increase conductivity through the graphene.

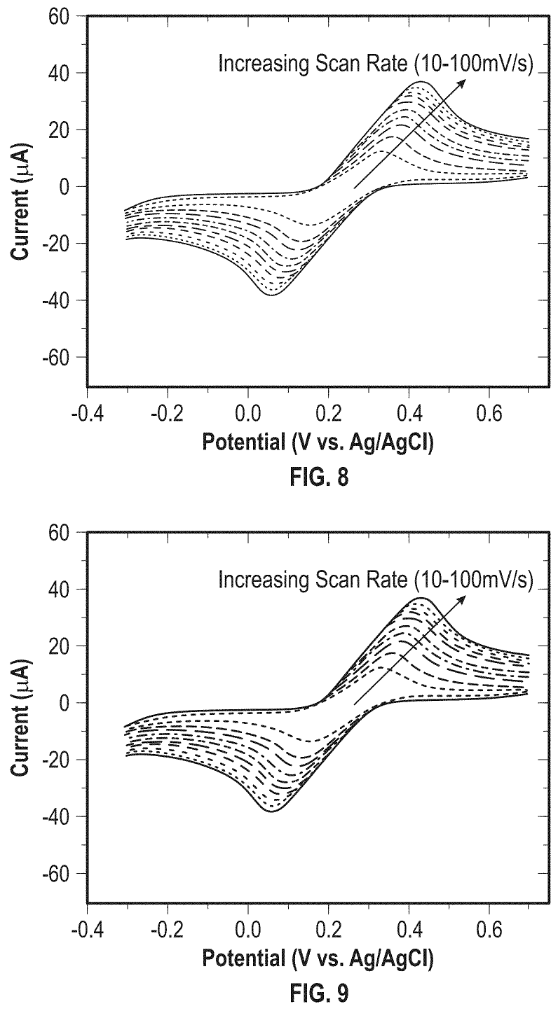

FIG. 7 is a graph depicting a voltage-current response of a graphene trace printed with 15 print passes on a Si/SO2 substrate at multiple scan rates. FIG. 8 is a graph depicting a voltage-current response of a graphene trace printed with 20 print passes on a Si/SO2 substrate at multiple scan rates. FIG. 9 is a graph depicting a voltage-current response of a graphene trace printed with 25 print passes on a Si/SO2 substrate at multiple scan rates.

Each of the graphene traces used to generate the data of FIGS. 7-9 may have been annealed at 350 degrees C. for two hours. As shown in FIG. 7, for a scan rate of 10 mV/s, ΔE is about 185 mV. As shown in FIG. 8, for a scan rate of 10 mV/s, ΔE is about 160 mV. As shown in FIG. 9, for a scan rate of 10 mV/s, ΔE is about 136 mV.

An ideal electrode, meaning a fully reversible electrode, may have an anodic peak current to a cathodic peak current (Ipa/Ipc) ratio of 1 and ΔEₚ potential of 59 mV. In FIGS. 7-9, clear maxima in the cathodic and anodic currents can be observed, as well a peak separation, aided by uniformity of the printed graphene. The current-voltage (CV) curve shows the peak-peak separation is about 196 mV at a scan rate of 100 mV/s, which is much greater than an ideal electrode. This high peak-to-peak separation could be due to the high scan rate of the CV scan or quasi-reversibility of the electrode.

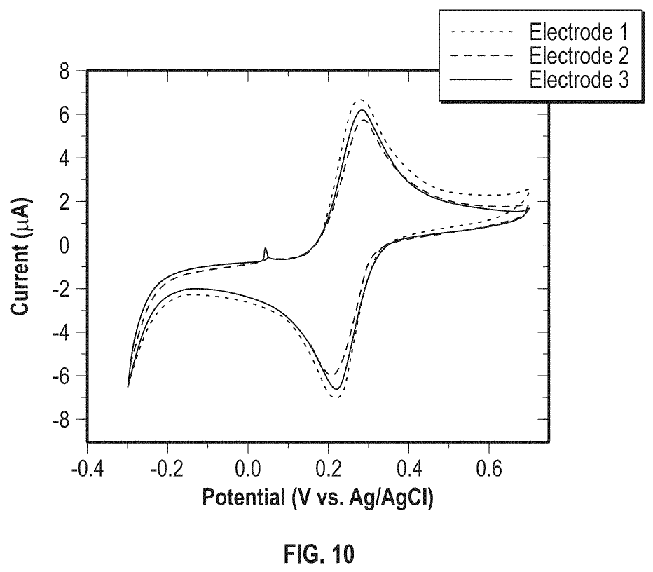

FIG. 10 shows a voltage-current response of multiple graphene electrodes printed on a Si/SO2 substrate. FIG. 10 demonstrates the repeatability of the methods described herein. Typical methods may not be not result in repeatability.

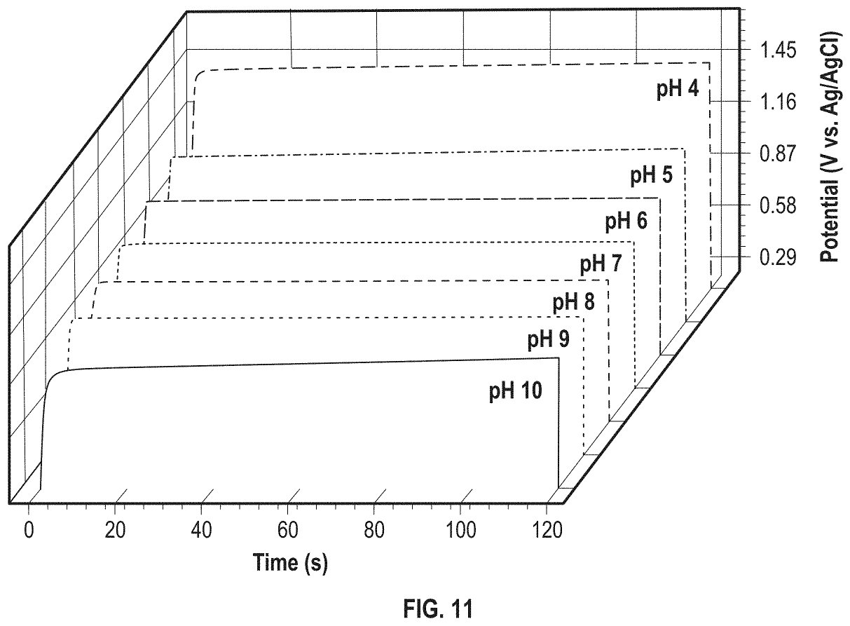

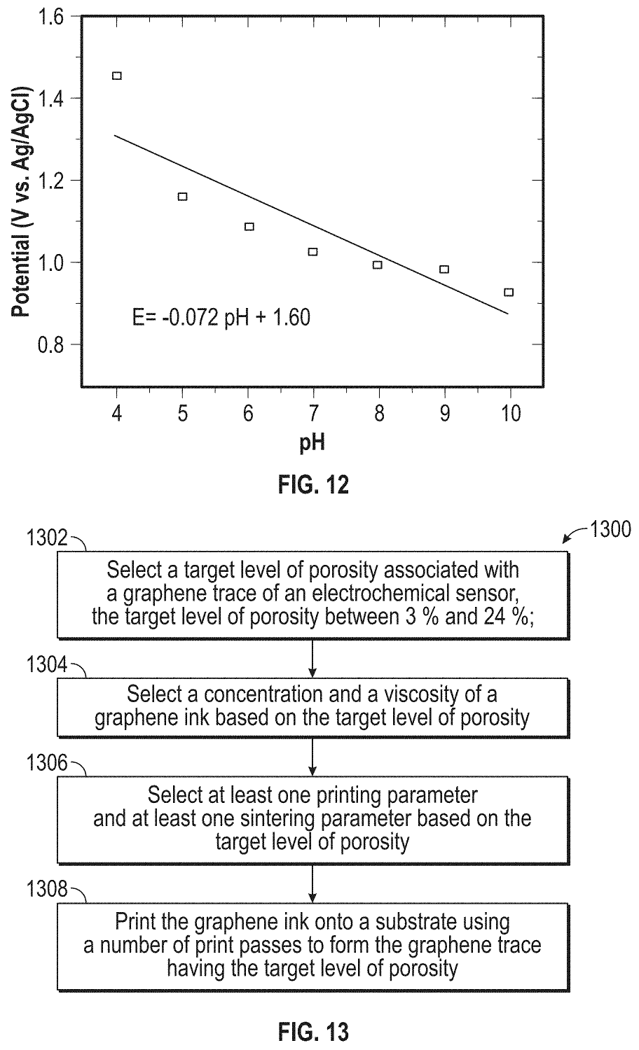

FIG. 11 is a graph depicting a pH response of a graphene electrode printed on a Si/SO2 substrate as a function of time for multiple pH levels. FIG. 12 is a graph depicting a pH response of graphene electrodes as a function of pH. The pH response of the graphene traces in a biosensor was comparable to that of a conventional glass electrode over three pH values of 4, 7 and 10. Key parameters for sensing performance including the uniformity of the printed electrodes, the response time, the stability, and the reproducibility. Based on these parameters, graphene traces may be printed to produce biosensors as described herein.

Referring to FIG. 13, an embodiment of a method 1300 for forming a graphene-based sensor is depicted. The method 1300 may include selecting a target level of porosity associated with a graphene trace of an electrochemical sensor, the target level of porosity between 3% and 24%, at 1302. For example, the target porosity 112 may be selected and associated with the graphene trace 170.

The method 1300 may further include selecting a concentration and a viscosity of a graphene ink based on the target level of porosity, at 1304. For example, the concentration 138 and the viscosity 140 may be selected based on the target level of porosity 112.

The method 1300 may also include selecting at least one printing parameter and at least one sintering parameter based on the target level of porosity, at 1306. For example, the printing parameters 152 and the sintering parameters 160 may be selected based on the target level of porosity 112.

The method 1300 may include printing the graphene ink onto a substrate using a number of print passes to form the graphene trace having the target level of porosity, at 1308. For example, the graphene ink 136 may be printed onto the substrate 174.

A benefit of the method 1300 is that repeatable electrical characteristics of a graphene trace may be achieved. Other benefits may exist.

Although various embodiments have been shown and described, the present disclosure is not so limited and will be understood to include all such modifications and variations as would be apparent to one skilled in the art.

What is claimed is:

1. A method comprising:
selecting a target level of porosity associated with a graphene trace of an electrochemical sensor, the target level of porosity between 3% and 24%;
selecting a concentration and a viscosity of a graphene ink based on the target level of porosity;
selecting at least one printing parameter and at least one sintering parameter based on the target level of porosity; and
printing the graphene ink onto a substrate using a number of print passes to form the graphene trace having the target level of porosity.

2. The method of claim 1, wherein the target level of porosity is selected to be 15%.

3. The method of claim 1, wherein the concentration of the graphene ink is selected to be about 3.5 mg/ml.

4. The method of claim 1, wherein the viscosity of the graphene ink is selected to be about 3.6 cP.

5. The method of claim 1, wherein the at least one printing parameter includes a number of print passes and is selected to be between 10 and 30.

6. The method of claim 1, wherein the at least one sintering parameter includes a sintering temperature selected to be at least 350° C. and a sintering time selected to be at least 60 mins. for an inkjet printing process.

7. The method of claim 1, wherein the at least one sintering parameter includes a sintering temperature selected to be at least 200° C. and a sintering time selected to be at least 60 mins. for an aerosol jet printing process.

8. The method of claim 1, further comprising:
dispersing dried graphene flakes into a mixture of cyclohexanone and terpineol to form the graphene ink.

9. The method of claim 8, wherein printing the graphene ink comprises using an inkjet process, and wherein the mixture of cyclohexanone and terpineol includes 85 wt % cyclohexanone and 15 wt % terpineol.

10. The method of claim 8, wherein printing the graphene ink comprises using an aerosol jet process, and wherein the mixture of cyclohexanone and terpineol includes 92.5 wt % cyclohexanone and 7.5 wt % terpineol.

11. The method of claim 1, wherein the substrate is a flexible substrate configured to conform to a biological surface with the graphene trace in contact with the biological surface.

12. A method comprising:
dispersing dried graphene flakes into a mixture of cyclohexanone and terpineol to form a graphene ink having a graphene concentration of about 3.5 mg/ml and a viscosity of about 3.6 cP; and
printing the graphene ink onto a substrate to form a graphene trace, the graphene trace defining a portion of an electrochemical sensor, the graphene trace having a level of porosity of about 15%.

13. The method of claim 12, wherein printing the graphene ink onto the substrate comprises using between 10 and 30 print passes.

14. The method of claim 12, wherein printing the graphene ink comprises using an inkjet process, wherein the cyclohexanone is 85% and the terpineol is 15%.

15. The method of claim 14, further comprising sintering the graphene trace for 60 minutes at 350° C.

16. The method of claim 12, wherein printing the graphene ink comprises using an aerosol process, wherein the cyclohexanone is 92.5% and the terpineol is 7.5%.

17. The method of claim 16, further comprising sintering the graphene trace for 60 minutes at 350° C.

18. The method of claim 12, further comprising:
forming the dried graphene flakes by adding bulk powders to a solution of 4% ethyl cellulose in ethanol to form a bulk mixture, probe tip sonicating the bulk mixture for at least 90 minutes, centrifuging the bulk mixture at 4500 rotations per minute for at least 60 minutes to form a supernatant, adding the supernatant to a 0.04 g/ml aqueous solution of NaCl to form a graphene mixture, centrifuging the graphene mixture for 15 minutes at 4500 rotations per minute, and drying the graphene mixture on a Polytetrafluoroethylene plate.

19. A system comprising:
a substrate; and
a printed graphene trace having a porosity of between 3% and 24% printed onto the substrate, wherein the printed graphene trace defines at least a portion of an electrochemical sensor.

20. The system of claim 19, wherein the porosity is about 15%.
